(19) United States
(12) Patent Application Publication
(10) Pub. No.: US 2023/0288617 A1
(43) Pub. Date: Sep. 14, 2023

(54) OPTICAL SYSTEM AND CAMERA MODULE

(71) Applicant: Sharp Sensing Technology Corporation, Tenri City (JP)

(72) Inventors: Akihiro IIDA, Tenri City (JP); Yoshihito ISHIZUE, Tenri City (JP)

(21) Appl. No.: 17/971,628

(22) Filed: Oct. 23, 2022

(30) Foreign Application Priority Data
Mar. 11, 2022 (JP) 2022-038198

(51) Int. Cl. G02B 3/14; G03B 17/17

(52) U.S. Cl. CPC G02B 3/14; G03B 17/17

(57) ABSTRACT

An optical system includes the following: a first lens group including two or more lenses, having a positive power as a whole, and configured to pass object light; and a variable-focal-length lens configured to receive the object light that has passed through the first lens group, and capable of changing a focal length. An object that emits the object light undergoes focusing based on a power change in the variable-focal-length lens.

### CROSS-REFERENCE TO RELATED APPLICATION

The present application claims priority from Japanese Application JP2022-038198, the content of which is hereby incorporated by reference into this application.

### BACKGROUND OF THE INVENTION

### 1. Field of the Invention

The present invention relates to an optical system that includes a variable-focal-length lens that concentrates object light on its image pickup unit, and to a camera module.

### 2. Description of the Related Art

A camera module of a whole-group extension type has been conventionally known (Japanese Patent No. 5611533) that includes a plurality of image pickup lenses for taking a subject's image, a lens barrel holding the plurality of image pickup lenses, and a lens driver that drives the lens barrel, and the camera module extends the lens barrel holding this set of image pickup lenses.

Further, another camera module of the whole-group extension type has been known (U.S. patent Ser. No. 10/371,928) that includes a reflective element, such as a prism or mirror, that is anterior to a plurality of image pickup lenses in order to thin a smartphone incorporating the camera module, and the reflective element can incline the optical axis of light from a subject, from a direction perpendicularly to the smartphone's backside to a direction parallel to the smartphone's backside.

Furthermore, another camera module has been known (Chinese Patent No. 109975973) that includes not a conventional single focal length lens, but a variable-focal-length lens, a liquid lens for instance, to suppress lens extension.

### SUMMARY OF THE INVENTION

Unfortunately, Japanese Patent No. 5611533 requires a clearance for the image pickup lenses to move in the direction along the optical axis by a length equal to the amount of extension in the whole-group extension type; hence, a camera module that includes a telephoto lens with a long focal length particularly involves a large amount of extension, thus upsizing the camera module and making it difficult to downsize and slim down the camera module.

Further, when the whole-group extension type is combined with a folding optical system in order to solve this problem, as described in U.S. patent Ser. No. 10/371,928, a clearance distance equal to or larger than the amount of whole-group lens extension in the lens driver is required between the lenses and the reflective element.

Light rays spread out by the field angle of the lenses in accordance with this clearance distance. The reflective element needs to be also upsized along with the light ray spread, thus increasing the thickness and footprint of the camera module as well.

Accordingly, an attempt to obtain a camera module of this type with a large amount of whole-group extension results in an upsized camera module similarly, and downsizing and thickness reduction are difficult to achieve.

It is noted that using a variable-focal-length lens, such as a liquid lens, as described in Chinese Patent No. 109975973 promises to reduce the amount of lens extension, but a liquid lens, when used actually, unfortunately involves problems in its optical performance, in particular, a chromatic aberration or a comatic aberration.

One aspect of the present invention is aims to downsize and slim down an optical system and a camera module.

To solve the above problem, an optical system according to one aspect of the present invention includes the following: a first lens group including two or more lenses, having a positive power as a whole, and configured to pass object light; and a variable-focal-length lens configured to receive the object light that has passed through the first lens group, and capable of changing a focal length, wherein an object that emits the object light undergoes focusing based on a power change in the variable-focal-length lens.

To solve the above problem, a camera module according to another aspect of the present invention includes the following: the optical system according to the one aspect of the present invention; and an image pickup unit having an image formation surface to which the object light that has passed through the optical system converges, and configured to subject the object light that has converged on the image formation surface to photoelectric conversion.

The aspects of the present invention can downsize and slim down an optical system and a camera module.

### BRIEF DESCRIPTION OF THE DRAWINGS

FIG. 1 is a perspective view of a camera module according to a first preferred embodiment;

FIG. 2 is a sectional view taken along line A-A in FIG. 1;

FIG. 3 illustrates a configuration of an optical unit provided in the camera module;

FIG. 4 illustrates a configuration of an optical unit provided in a camera module according to a second preferred embodiment;

FIG. 5 is a perspective view of a camera module according to a comparative example;

FIG. 6 is a sectional view taken along line B-B in FIG. 5; and

FIG. 7 is a perspective view of a camera module according to another comparative example.

### DETAILED DESCRIPTION OF THE INVENTION

### First Preferred Embodiment

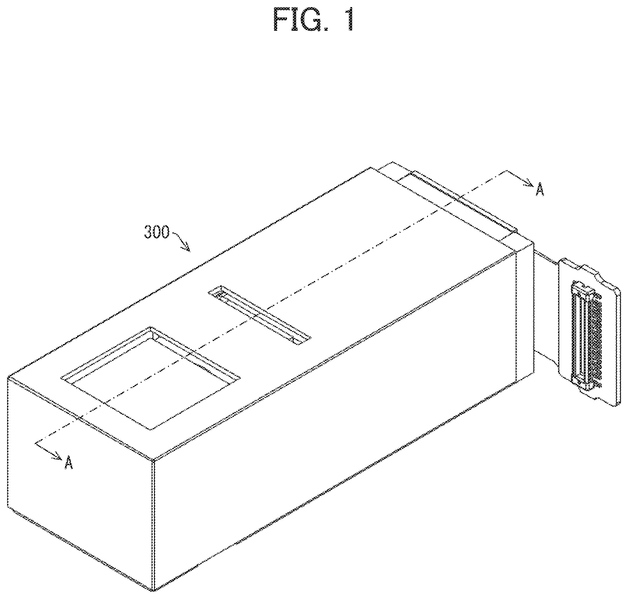

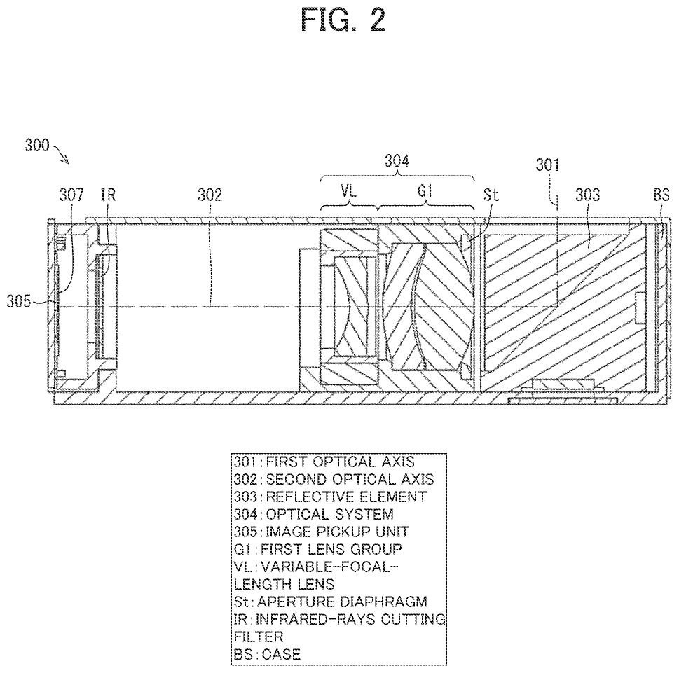

One preferred embodiment of the present invention will be detailed. FIG. 1 is a perspective view of a camera module 300 according to a first preferred embodiment. FIG. 2 is a sectional view taken along line A-A in FIG. 1 and corresponds to a sectional view of the camera module 300 with its middle part cut in a direction along the optical axis.

The camera module 300 includes an optical system 304, and an image pickup unit 305 having an image formation surface 307 to which object light that has passed through the optical system 304 converges, and configured to subject the object light to photoelectric conversion.

The optical system 304 has a first lens group G1 including two or more lens, having a positive power as a whole and configured to receive object light, and a variable-focal-length lens VL configured to receive the object light that has passed through the first lens group G1, and capable of changing a focal length.

Moreover, the camera module 300 further includes a reflective element 303 anterior to the first lens group G1 of the optical system 304. The reflective element 303 guides object light emitted along a first optical axis 301 to the optical system 304 along a second optical axis 302. The optical system 304 concentrates the object light on the image formation surface 307 along the second optical axis 302.

The first lens group G1 and the image pickup unit 305 are fastened to a case BS so that the distance between the first lens group G1 and image pickup unit 305 in a direction along the second optical axis 302 does not vary in focusing on a close-range object that emits object light.

The camera module 300 according to the first preferred embodiment includes the following, as illustrated in FIG. 2: the reflective element 303 disposed closest to a subject and configured to guide, along the second optical axis 302, light from the subject and along the first optical axis 301; the optical system 304 posterior to the reflective element 303; and the image pickup unit 305 configured to subject the light that has passed through the optical system 304 to photoelectric conversion.

The optical system 304 includes a first lens group G1 including a first lens L1 located closest to the reflective element 303, and the variable-focal-length lens VL posterior to the first lens group G1.

The camera module 300 further includes an aperture diaphragm St incorporated in the optical system 304, an infrared-rays cutting filter IR disposed forward of the image pickup unit 305, and the case BS supporting all the foregoing components directly or indirectly.

The reflective element 303 bends light rays that travel along the first optical axis 301 from a subject, guides the light rays along the second optical axis 302 and transmits the light rays to the optical system 304. Although the angle at which the reflective element 303 bends the light rays, that is, the angle between the first optical axis 301 and the second optical axis 302 is preferably 90 degrees, the angle can be changed as appropriate and is not limited to 90 degrees.

Further, although various reflective materials, including a prism and a reflective plate (mirror), can be used as appropriate for the reflective element 303, a prism is preferably used in view of processing accuracy.

Furthermore, the reflective element 303, which is supported by the case BS of the camera module 300, can achieve the function of optical hand-induced-shake correction, as described later on, by the provision of a driving mechanism between the reflective element 303 and the case BS.

The optical system 304 concentrates light rays guided along the second optical axis 302 by the reflective element 303 onto the image formation surface 307 of the image pickup unit 305 to form an image.

The optical system 304, which includes the first lens group G1, the variable-focal-length lens VL, and the aperture diaphragm St and is supported by the case BS, can achieve the function of optical hand-induced-shake correction, as described later on, by the provision of a driving mechanism between the optical system 304 and the case BS.

It is noted that various preferred embodiments relating to the optical performance of the camera module 300 according to this preferred embodiment are achieved by the respective configurations of the first lens L1 to a fourth lens of the optical system 304, as described later on.

The variable-focal-length lens VL is a liquid lens for instance and can change a focal length by changing the curvature radius of the lens, thereby preforming focusing. Such a liquid lens has a refractive surface that is formed by changing the shape of a liquid through electro-wetting, a phenomenon where the wetting property of a liquid changes upon voltage application to the liquid, and is used as a variable-focal-length lens.

The liquid lens includes the following for instance: an immiscible first fluid and an immiscible second fluid having refractive indexes different from each other and capable of coming into contact via a meniscus; a cylindrical fluid chamber having a cylinder wall and housing the first fluid and the second fluid; a fluid contact layer disposed inside the cylinder wall; a first electrode separated from the first fluid and second fluid by the fluid contact layer; and a second electrode for activating the second fluid.

Under no voltage application between the first electrode and the second electrode, the fluid contact layer has wettability higher with respect to the first fluid than that with respect to the second fluid. Upon voltage application between the first electrode and the second electrode, the wettability resulting from the second fluid changes due to electro-wetting, thus changing the angle of contact formed by the meniscus. Accordingly, the applied voltage changes the shape of the meniscus to thus change the curvature radius of the lens; by using this, the liquid lens undergoes focal-point adjustment.

However, the variable-focal-length lens VL can be composed of other variable-focal-length lenses, such as a soft polymer, and is not limited to a liquid lens.

A soft-polymer lens includes, for instance, a soft polymer, a transparent material with flexibility, and a driving part that deforms the flexible transparent material, and the lens is used as a variable-focal-length lens having a refractive surface that is formed by deforming, in the driving part, the flexible transparent material.

A soft-polymer lens includes, for instance, a substrate provided with a recess, an upper cover layer formed so as to cover the substrate's recess, a soft polymer disposed within the substrate's recess, and a piezoelectric ring disposed in a location corresponding to the perimeter of the recess above the upper cover layer.

The upper cover layer, which is thin, and the piezoelectric ring act in cooperation as a bimorph driving part. For instance, a contraction of the piezoelectric ring forms a protrusion in the upper cover layer. The upper cover layer provides a curved surface, and the curved surface constitutes a substantially spherical refractive surface in the middle, thus offering a lens. The lower surface of the soft polymer follows the soft polymer to move up and is pulled up to form a protrusion in the upper cover layer, thereby offering a meniscus lens.

The optical system 304 concentrates light rays guided along the second optical axis 302 by the reflective element 303 onto the image pickup unit 305 to form an image.

The image pickup unit 305 is a sensor device that converts, through photoelectric conversion, light rays concentrated on the image formation surface 307 by the optical system 304 into electric signals. The electric signals undergo software processing and are finally output to an image.

The image pickup unit 305 can achieve the function of optical hand-induced-shake correction, as described later on, by the provision of a driving mechanism between the image pickup unit 305 and the case BS.

The infrared-rays cutting filter IR has the function of blocking infrared rays contained in light that enters the image pickup unit 305.

Further, if a foreign substance (dust) attaches to the image pickup unit 305 directly, the convergence of light is hindered, degrading an image seriously; hence, the infrared-rays cutting filter IR is provided forward of the image pickup unit 305 and thus has the function of reducing the risk of direct attachment of a foreign substance to the image pickup unit 305.

It is noted that the camera module 300 according to this preferred embodiment can offer a configuration that achieves optical hand-induced-shake correction by rotating the reflective element 303 about any two axes.

The foregoing configuration includes the following: a shake detecting means for detecting a hand-induced shake; a controller that controls a driving part for the reflective element 303 on the basis of a signal sent from the shake detecting means; the driving part for rotating the reflective element 303; and a retainer holding the reflective element 303 to propagate the operation of the driving part to move the reflective element 303.

Alternatively, the camera module 300 according to this preferred embodiment can offer a configuration that achieves optical hand-induced-shake correction by moving the optical system 304 in parallel with any two axes.

The foregoing configuration includes the following: a shake detecting means for detecting a hand-induced shake; a controller that controls a driving part for the optical system 304 on the basis of a signal sent from the shake detecting means; the driving part for moving the optical system 304; and a retainer holding the optical system 304 to propagate the operation of the driving part to move the optical system 304.

Further alternatively, the camera module according to this preferred embodiment can offer a configuration that achieves optical hand-induced-shake correction by moving the image pickup unit 305 in parallel with any two axes.

The foregoing configuration includes the following: a shake detecting means for detecting a hand-induced shake; a controller that controls a driving part for the image pickup unit 305 on the basis of a signal sent from the shake detecting means; the driving part for moving the image pickup unit 305; and a retainer holding the image pickup unit 305 to propagate the operation of the driving part to move the image pickup unit 305.

Any of these configuration achieves optical hand-induced-shake correction through driving of two axes of constituent components; thus, combining the driving direction of one component and the driving direction of another component together, e.g., one axis for the rotation axis of the reflective element 303, and another axis for the movement axis of the optical system 304, can also achieve optical hand-induced-shake correction.

These configurations that achieve optical hand-induced-shake correction are known commonly, and their detailed description and illustration will be thus omitted.

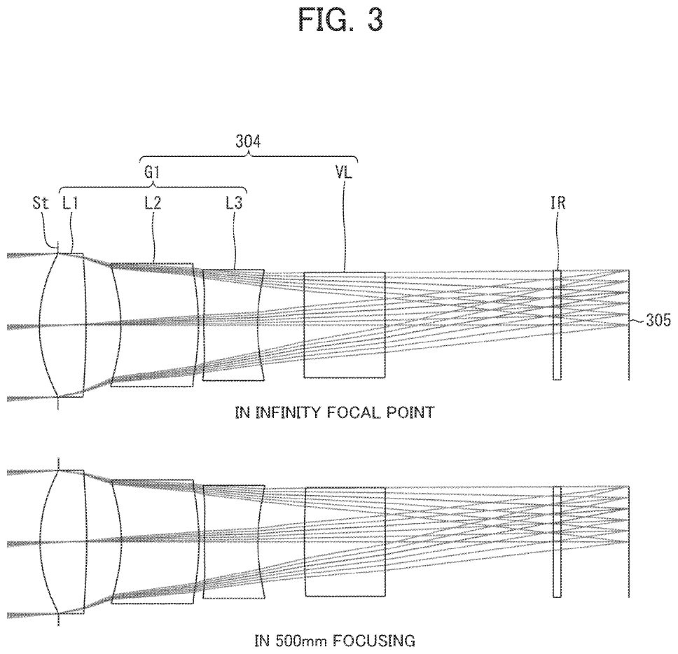

One preferred embodiment relating to the optical system 304 according to this preferred embodiment will be described based on FIG. 3 and Table 1, which shows lens data according to this preferred embodiment.

TABLE 1
f = 23.3 mm (35 mm-equivalent f = 240 mm)
Fno = 4.4
Ω = 5.0 deg.
Ih = 2.050 mm
TTL = 21.11 mm
Surface Data

| | Curvature | Plane | Refractive | Abbe's |
|---|---|---|---|---|
| Surface | Radius | Interval | Index | Number |
| Number i | r (mm) | t (mm) | Nd | vd |
| Subject | Infinity | Infinity | | |
| | | 500 mm | | |
| 1 (Diaphragm) | Infinity | −0.686 | | |
| 2* | 5.302 | 1.727 | 1.544 | 55.93 |
| 3* | −33.148 | 1.285 | | |
| 4* | −5.456 | 2.865 | 1.650 | 21.54 |
| 5* | −10.404 | 0.200 | | |
| 6* | 19.863 | 1.982 | 1.535 | 55.69 |
| 7* | 6.214 | 1.723 | | |
| 8 | INF: Infinity | 0.300 | 1.33 | 100.0 |
| | 500 mm: 39.001 | | | |
| 9 | Infinity | 6.213 | | |
| 10 | Infinity | 0.300 | 1.517 | 64.17 |
| 11 | Infinity | 2.500 | | |
| Imaging Surface | Infinity | | | |

Aspheric Surface Data

| | Surface 2 | Surface 3 | Surface 4 | Surface 5 | Surface 6 | Surface 7 |
|---|---|---|---|---|---|---|
| k | 0.000E+00 | 0.000E+00 | 0.000E+00 | 0.000E+00 | 0.000E+00 | 0.000E+00 |
| A4 | −4.092E−04 | −7.736E−04 | 4.246E−03 | −1.928E−03 | −1.173E−02 | −6.085E−03 |
| A6 | −8.279E−06 | 9.700E−05 | 1.170E−04 | 7.861E−04 | 5.872E−04 | −7.949E−05 |
| A8 | −2.845E−07 | −1.133E−06 | −7.138E−06 | −4.801E−05 | 4.723E−05 | 1.128E−04 |
| A10 | 0.000E+00 | 0.000E+00 | 1.842E−07 | 3.118E−06 | −2.997E−06 | −8.354E−06 |

It is noted that in Table 1, f denotes the overall focal length of the optical system 304, Fno denotes F number, ω denotes half angle of view (degree), and ih denotes maximum image height. Further, i denotes surface number counted from a subject, r denotes curvature radius, t denotes inter-lens-surface distance, Nd denotes the refractive index of line d, vd denotes Abbe's number with respect to line d, and TTL denotes distance from a near-object surface of a lens located closest to the reflective element 303 in the first lens group G1 to the image pickup unit 305. It is noted that the aspheric surfaces are each denoted by surface number i with an asterisk (*).

Further, an aspheric shape that is used for the aspheric surfaces of the lens surfaces is expressed by Expression 1 below, where z denotes an axis in a direction along the optical axis, where h denotes a height in a direction orthogonal to the optical axis, where k denotes a conic constant, where A4, A6, A8, and A10 denote aspheric coefficients. This holds true for Table 2.

$$z = \frac{\frac{{h}^{2}}{r}}{1 + \sqrt{1 - \frac{( 1 + k ) {h}^{2}}{{r}^{2}}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} \qquad [ Expression 1 ]$$

FIG. 3 is a schematic diagram of optical lenses of the optical system 304 of the camera module 300 according to the first preferred embodiment. The optical system 304 is composed of, in sequence from near an object, a diaphragm St, the first lens group G1, which has a positive power as a whole, and the variable-focal-length lens VL; here, the first lens group G1 is composed of the first lens L1 having a positive power, a second lens L2 having a negative power, and a third lens L3 having a negative power.

The lens data in the first preferred embodiment is shown in Table 1.

A lens according to the first preferred embodiment has an actual focal length f of 23.3 mm, and a 35 mm-equivalent focal length of about 240 mm; a twin-lens camera having a 35 mm-equivalent focal length of 24 mm on its wide-angle side can achieve about ten times in zoom ratio.

Here, the following conditions are satisfied:

the overall actual focal length of the optical system 304, f=23.3 mm,

the focal length of the variable-focal-length lens VL in infinity imagining, f2I=0 mm,

the focal length of the variable-focal-length lens VL in close-range imagining, f2M=118.2 mm,

the overall maximum image height of the optical system 304, ih=2.050 mm,

the distance from the near-object surface of the first lens L1, which is located closest to an object in the first lens group G1, to the image formation surface 307, TTL=21.11 mm,

the overall F number of the optical system 304, Fno=4.4,

the optically effective diameter of the first lens group G1, De1=5.3 mm, and

the optically effective diameter of the variable-focal-length lens VL, De2=3.9 mm.

The optical system 304 according to the first preferred embodiment can change a focal length by changing the curvature of the variable-focal-length lens VL and can consequently perform focusing ranging from infinity imaging to close-range imaging. This preferred embodiment requires no lens extension; however, for a sensor of a 1/4.4 type, similar focusing through a conventional whole-group lens extension method requires a lens extension amount of 1.1 mm.

Placing the first lens group G1 having a positive power forward of the variable-focal-length lens VL, like that of the optical system 304 according to the first preferred embodiment, can favorably correct various aberrations, including a chromatic aberration and a comatic aberration in particular.

### Second Preferred Embodiment

Another preferred embodiment of the present invention will be described. It is noted that for convenience in description, components having the same functions as components described in the foregoing preferred embodiment will be denoted by the same signs, and their description will not be repeated.

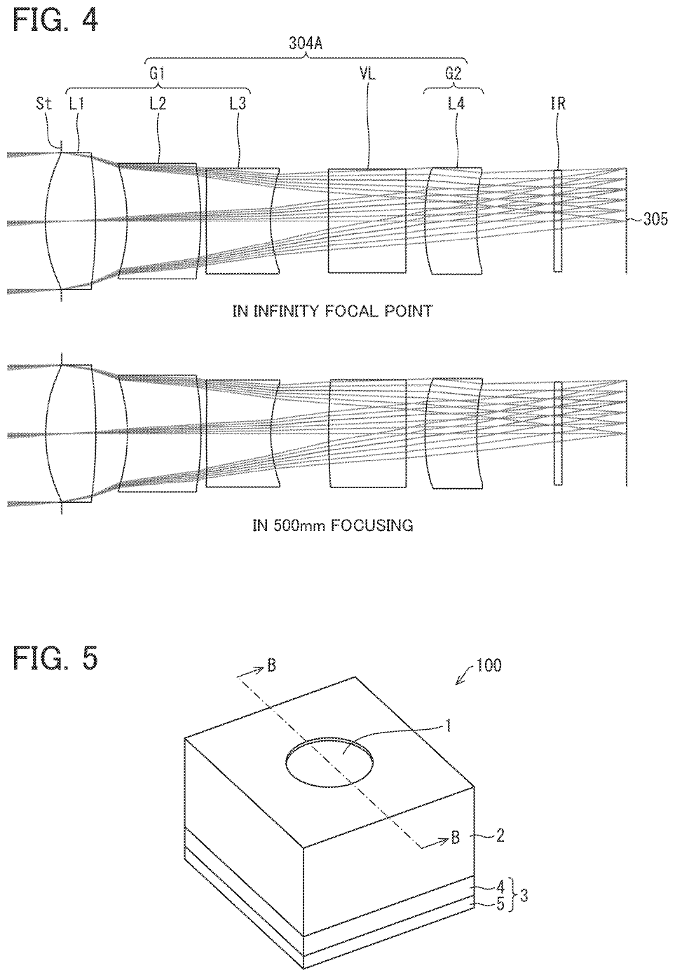

FIG. 4 illustrates a configuration of an optical system 304A provided in a camera module according to a second preferred embodiment. When compared with the optical system 304 according to the first preferred embodiment, the optical system 304A includes a second lens group G2 (fourth lens L4) in addition to a first lens group G1 and a variable-focal-length lens VL, both of which are included in the optical system 304.

TABLE 2
f = 23.3 mm (35 mm-equivalent f = 240 mm)
Fno = 4.4
Ω = 5.0 deg.
Ih = 2.050 mm
TTL = 21.87 mm
Surface Data

| | Curvature | Surface | Refractive | Abbe's |
|---|---|---|---|---|
| Surface | Radius | Interval | Index | Number |
| Number i | r (mm) | t (mm) | Nd | vd |
| Subject | Infinity | Infinity | | |
| | | 500 mm | | |
| 1 (Diaphragm) | Infinity | −0.630 | | |
| 2* | 5.827 | 1.952 | 1.544 | 55.93 |
| 3* | −19.267 | 1.217 | | |
| 4* | −6.314 | 2.854 | 1.650 | 21.54 |
| 5* | −12.547 | 0.200 | | |
| 6* | 26.403 | 2.500 | 1.535 | 55.69 |
| 7* | 5.035 | 2.245 | | |
| 8 | INF: Infinity | 3.000 | 1.33 | 100.0 |
| | 500 mm: 30.507 | | | |
| 9 | Infinity | 0.735 | | |
| 10* | 10.976 | 2.000 | 1.535 | 55.69 |
| 11* | 14.863 | 3.000 | | |
| 12 | Infinity | 0.300 | 1.517 | 64.17 |
| 13 | Infinity | 2.500 | | |
| Imaging Surface | | | | |

Aspheric Surface Data

| | Surface 2 | Surface 3 | Surface 4 | Surface 5 | Surface 6 | Surface 7 | Surface 10 | Surface 11 |
|---|---|---|---|---|---|---|---|---|
| k | 0.000E+00 | 0.000E+00 | 0.000E+00 | 0.000E+00 | 0.000E+00 | 0.000E+00 | 0.000E+00 | 0.000E+00 |
| A4 | −5.424E−05 | −2.959E−04 | 2.081E−03 | −2.941E−04 | −6.040E−03 | −3.772E−03 | 4.047E−03 | 5.663E−03 |
| A6 | −9.395E−06 | 2.068E−05 | 5.858E−05 | 1.970E−04 | 8.717E−05 | −5.258E−05 | 2.507E−04 | 4.104E−04 |
| A8 | −4.409E−07 | −2.217E−07 | −4.244E−06 | −1.122E−05 | 2.252E−05 | 7.258E−05 | −4.405E−05 | 1.081E−05 |
| A10 | 0.000E+00 | 0.000E+00 | 1.082E−07 | 2.487E−07 | −1.169E−06 | −4.230E−06 | 8.130E−06 | −6.318E−06 |
| A12 | 0.000E+00 | 0.000E+00 | 0.000E+00 | 0.000E+00 | 0.000E+00 | 0.000E+00 | −3.953E−07 | 2.121E−06 |

The data of the lenses provided in the optical system 304A of the camera module according to the second preferred embodiment is shown in Table 2.

The lenses according to the second preferred embodiment have an actual focal length of 23.4 mm, and a 35 mm-equivalent focal length of about 245 mm; a twin-lens camera having a 35 mm-equivalent focal length of 24 mm on its wide-angle side can achieve about ten times in zoom ratio.

Here, the following conditions are satisfied:

the overall actual focal length of the optical system 304A, f=23.3 mm,

the focal length of the variable-focal-length lens VL in infinity imagining, f2I=0 mm,

the focal length of the variable-focal-length lens VL in close-range imagining, f2M=92.4 mm,

the overall maximum image height of the optical system 304A, ih=2.050 mm,

the distance from the near-object surface of the first lens L1, which is located closest to an object in the first lens group G1, to an image formation surface 307, TTL=21.87 mm,

the overall F number of the optical system 304A, Fno=4.4,

the optically effective diameter of the first lens group G1, De1=5.3 mm, and the optically effective diameter of the variable-focal-length lens VL, De2=4.2 mm.

The optical system 304A according to the second preferred embodiment can change a focal length by changing the curvature of the variable-focal-length lens VL and can consequently perform focusing ranging from infinity imaging to close-range imaging. This preferred embodiment requires no lens extension; however, for a sensor of a 1/4.4 type, similar focusing through a conventional whole-group lens extension method requires a lens extension amount of 1.1 mm.

The optical system 304A according to the second preferred embodiment, which includes the second lens group G2 (fourth lens L4) having a positive power backward of the variable-focal-length lens VL, can correct various aberrations generated by the variable-focal-length lens VL, including a spherical aberration in particular.

### Comparative Example

FIG. 5 is a perspective view of a camera module 100 according to a comparative example. The camera module 100 is a camera module of a straight type described in Japanese Patent No. 5611533. The camera module 100 is composed of the following: an optical unit 1, which is an optical image-pickup system; a lens driver 2 configured to drive the optical unit 1; and an image pickup unit 3 configured to subject light that has passed through the optical unit 1 to photoelectric conversion. The optical unit 1 is held inside the lens driver 2. The image pickup unit 3 is composed of a sensor 4, and a substrate 5 on which the sensor 4 is mounted. The camera module 100 is configured such that the sensor 4 and the lens driver 2 are stacked on the substrate in this order in a direction along the optical axis. For convenience, a side where the optical unit 1 is located will be hereinafter referred to as top, and a side where the image pickup unit 3 is located will be hereinafter referred to as bottom.

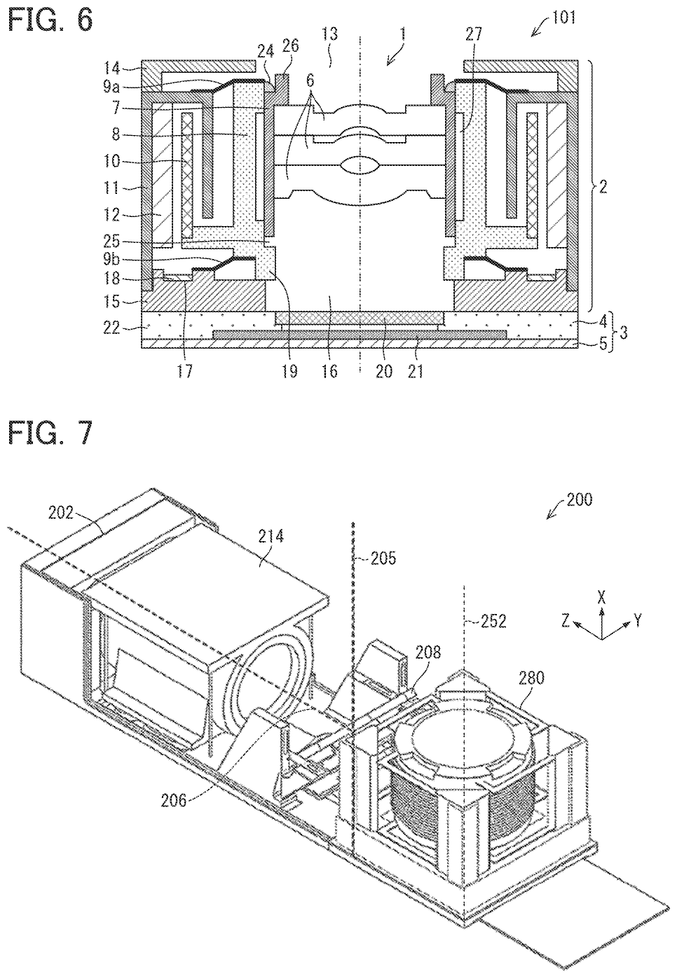

FIG. 6 is a sectional view taken along line B-B in FIG. 5. The following describes the overall structure of the camera module 100 on the basis of FIG. 6. FIG. 6 is a sectional view of the camera module 100 with its middle part cut in the direction along the optical axis.

The optical unit 1 is an optical image-pickup system that forms an image of a subject and guides external light to the sensor 4 of the image pickup unit 3. The optical unit 1 is composed of a plurality of image pickup lenses 6 (three image pickup lenses 6 in FIG. 6), and a lens barrel 7 holding the image pickup lenses 6. The lens barrel 7 is fastened to the lens driver 2. The optical axis of the image pickup lenses 6 coincides with the axial core of the lens barrel 7.

The lens driver 2, which is operated by a voice coil motor (VCM), is mounted on the camera module 100. The lens driver 2 drives the optical unit 1 in the direction along the optical axis with an electromagnetic force. That is, the lens driver 2 raises or lowers the image pickup lenses 6 between the infinity end and the macro end. The camera module 100 accordingly exerts its auto-focus function. Such a type in which the lens barrel 7 holding the set of image pickup lenses 6 is extended is called a whole-group extension type.

The lens driver 2 includes the following: a movable part that moves in the direction along the optical axis to move the optical unit 1 (image pickup lenses 6) in the direction along the optical axis when the image pickup lenses 6 undergo driving; and a fixed part that does not change position when the image pickup lenses 6 undergo driving. The movable part is housed within the fixed part. The movable part is composed of a lens holder 8 and a coil 10, and the fixed part is composed of a yoke 11, a permanent magnet 12, a cover 14, and a base 15.

The coil 10 is fastened to the outer end (flange) of the lens holder 8. The coil 10 extends from the outer end (bottom) of the lens holder 8 toward the incidence of light (toward an opening 13, which will be described later on).

The base 15 constitutes the bottom of the lens driver 2 and is provided with the sensor 4 on the back surface. The base 15 has, in its middle part, an opening 16 bored to establish an optical path.

The yoke 11 is a pipe-shaped member and constitutes the side surface of the lens driver 2. The yoke 11 houses the movable part. The yoke 11 is fastened on the base 15. The cover 14 is provided above the yoke 11. The cover 14 constitutes the upper part (top surface) of the lens driver 2.

The yoke 11 has an inner side surface on which a magnetic circuit composed of the permanent magnet 12 is disposed so as to face the coil 10.

The lens driver 2 drives the image pickup lenses 6 in the direction along the optical axis with an electromagnetic force generated by the coil 10 and permanent magnet 12. To be specific, in this preferred embodiment, feeding a current through the coil 10 within a magnetic field formed by the permanent magnet 12 produces a force, with which the image pickup lenses 6 (lens holder 8) can be driven in the direction along the optical axis.

Further, the lens driver 2 has plate springs 9a and 9b provided on the upper and lower surfaces (top and bottom surfaces) of the lens holder 8. The plate springs 9a and 9b press the lens holder 8 in the direction along the optical axis. That is, the plate springs 9a and 9b support the lens holder 8 accessorily with their elastic force in such a manner that the lens holder 8 can move in the direction along the optical axis. The plate springs 9a and 9b have a spiral pattern. Each of the plate springs 9a and 9b needs to be fasted to the movable part at one of its ends and needs to be fastened to the fixed part at the other end.

When the camera module 100 remains assembled, the lens holder 6 is pressurized downward by the elastic force of the plate springs 9a and 9b with a protrusion 19, formed on the bottom surface of the lens holder 8, being in contact with the base 15, as illustrated in FIG. 6.

The thickness of the camera module 100 of the aforementioned conventional straight type is specified based on the optical length between the lens distal end and the surface of an image pickup element, based on the thicknesses of the image pickup element, of a substrate and of other things, and based on the amount of whole-group lens extension for focusing. An addition of the optical length and the amount of whole-group extension will be referred to as an overall optical length.

The foregoing optical length is commonly proportional to a focal length (angle of field), and the foregoing amount of whole-group lens extension is commonly roughly proportional to the square of a focal length, as indicated by the following expressions:

1−a+1/b=1/f⇒b=af/(a−f), and

d=b−f=f²/(a−f²/a, where f<<a.

Here, a denotes the distance from a lens principle point to a subject, b denotes the distance from the lens principle point to an image formation surface, f denotes an actual focal length, and d denotes the amount of whole-group lens extension necessary for focusing from the infinity onto location a.

For instance, the camera module 100 of the conventional straight structure mainly includes a wide-angle lens and has a 35 mm-equivalent focal length of about 25 mm. For a sensor of a ½ type, the optical length measures 5 mm, and the amount of whole-group extension for 10 cm focusing measures about 0.2 mm on the basis of the forgoing expressions.

By the way, modern commercialized multi-lens or multi-camera-equipped electronic apparatuses, such as smartphones, incorporate a plurality of camera modules. These electronic apparatuses are equipped with camera modules each including a wide-angle camera as well as a super-wide-angle or telephoto lens, and in combination with digital correction, the apparatuses offer such usability as that of a zoom camera to a user.

For a twin-lens camera with a zoom factor of 4×, the telephoto side uses an optical system with a telephoto-side 35 mm-equivalent focal length of 100 mm when the wide-angle side has a 35 mm-equivalent focal length of 25 m. A sensor of the ½ type has an optical length of 19 mm and a whole-group extension amount of about 4.2 mm and thus has a module thickness equal to or greater than about four times of a camera that includes a sensor of the same size. The size of a sensor is often reduced on the telephoto side; a sensor of a ¼ type has an optical length of 10 mm and a whole-group extension amount of about 1.2 mm and thus has a twice or more thickness.

Accordingly, to reduce the thickness of this camera module on the telephoto side, a camera module structure for a folding optical system like one in FIG. 7 has been proposed. FIG. 7 is a perspective view of a camera module 200 according to another comparative example.

This folding camera module 200 includes a reflective element 208, such as a prism or a mirror, as illustrated in FIG. 7, and can incline the direction along the optical axis from a direction 205, which is perpendicular to the smartphone's backside, toward a direction 206, which is parallel to the smartphone's backside.

However, when a whole-group extension type and a folding optical system are combined in the camera module 200 shown in FIG. 7, a clearance distance equal to or larger than the amount of whole-group extension of a lens barrel 214 in its lens driver is required between the lens barrel 214 and the reflective element 208. Light rays spread out by the field angle of the lenses in accordance with this clearance distance. The reflective element 208 needs to be also upsized along with the light ray spread, thus increasing the thickness and footprint of the camera module 200 as well.

Thus, an attempt to obtain a lens driver with a large amount of whole-group extension results in upsizing of the camera module 200 and difficulty in downsizing and thickness reduction.

Lens driver upsizing leads to power consumption increase, affecting the battery duration of an electronic apparatus that is equipped with the camera module 200, terminal downsizing, and by extension, battery cost.

Further, a VCM-operated lens driver, whether it is a straight type or a folding type, is typically structured such that the movable part of the lens driver is supported by springs. Accordingly, spring resilience increases along with increase in focal length or in the amount of whole-group extension. Consequently, a considerable thrust is required, and the amount of spring deformation increases, thereby causing problems, such as a serious spring distortion. A spring distortion causes the driving axis of the lens driver to incline with respect to the optical axis; an inclined optical system induces degradation in the quality of a taken image.

In contrast to this, the optical systems 304 and 304A of the camera module 300 according to the first and second preferred embodiments are configured such that the first lens group G1, which includes two or more lenses, has a positive power as a whole and is configured to receive object light, and the second lens group G2, which includes one or more lenses, has a negative power as a whole and is posterior to the first lens group G1 to concentrate object light on the image pickup unit, satisfy the following conditional expressions:

−6.0<f/f2<−2.0 Conditional Expression (1),

ih/f<0.4 Conditional Expression (2),

0.7<TTL/f<1.0 Conditional Expression (3),

1.6<Fno<7.0 Conditional Expression (4), and

De2<De1 Conditional Expression (5).

Thus, changing the focal length of the variable-focal-length lens VL enables focusing on a close-range object that emits object light. This eliminates the need for using the whole-group extension type; changing the focal length of the variable-focal-length lens enables the foregoing focusing. The optical systems 304 and 304A and the camera module 300 can be consequently downsized and slimmed down.

### SUMMARY

An optical system 304, 304A according to a first aspect of the present invention includes the following: a first lens group G1 including two or more lenses (first lens L1, second lens L2), having a positive power as a whole, and configured to pass object light; and a variable-focal-length lens VL configured to receive the object light that has passed through the first lens group G1, and capable of changing a focal length, wherein an object that emits the object light undergoes focusing based on a power change in the variable-focal-length lens VL.

In the foregoing configuration, changing the focal length of a variable-focal-length lens enables focusing on a close-range object that emits object light. This eliminates the need for using a whole-group extension type; changing the focal length of a variable-focal-length lens enables the foregoing focusing. Consequently, the downsizing and slimming down of an optical system can be achieved.

In the first aspect, the optical system 304A according to a second aspect of the present invention preferably further includes a second lens group configured to receive the object light that has passed through the variable-focal-length lens, including one or more lenses, and having a positive power as a as a whole.

In the foregoing configuration, placing a second lens group having a positive power backward of a variable-focal-length lens can correct various aberrations, including a spherical aberration in particular.

The optical system 304, 304A according to a third aspect of the present invention is preferably configured, in the first or second aspect, such that the variable-focal-length lens is a liquid lens.

In the foregoing configuration, changing the liquid wettability of a liquid lens to change the curvature radius of the liquid lens enables focusing on a close-range object that emits object light.

The optical system 304, 304A according to a fourth aspect of the present invention is preferably configured, in the first or second aspect, such that the variable-focal-length lens is a lens composed of a soft polymer.

In the foregoing configuration, deforming, in a driving part, a flexible transparent material to form a refractive surface, thus changing the focal length of a lens enables focusing on a close-range object that emits object light.

A camera module 300 according to a fifth aspect of the present invention includes the following: the optical system 304, 304A according to any one of the first to fourth aspects of the present invention; and an image pickup unit 305 having an image formation surface 307 to which the object light that has passed through the optical system 304, 304A converges, and configured to subject the object light to photoelectric conversion.

In the foregoing configuration, a camera module includes the optical system according to one aspect of the present invention, and an image pickup unit configured to concentrate object light that has passed through the optical system. The camera module can be thus downsized and slimmed down.

In the fifth aspect, the camera module 300 according to a sixth aspect of the present invention preferably further includes a reflective element 303 disposed opposite the variable-focal-length lens VL with respect to the first lens group G1 of the optical system 304, wherein the reflective element 303 guides, along a second optical axis 302, the object light emitted along a first optical axis 301, and the optical system 304 concentrates the object light on the image formation surface 307 along the second optical axis 302.

The foregoing configuration, which can achieve a camera module structure for a folding optical system and can incline the direction along the optical axis from a direction perpendicular to the smartphone's backside toward a direction parallel to the smartphone's backside, is suitable in the present invention.

The present invention is not limited to the foregoing preferred embodiments. Various modifications can be devised within the scope of the claims. A preferred embodiment that is obtained in combination, as necessary, with the technical means disclosed in the respective preferred embodiments is also included in the technical scope of the present invention. Furthermore, combining the technical means disclosed in the respective preferred embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical system comprising:
a first lens group including two or more lenses, having a positive power as a whole, and configured to pass object light; and
a variable-focal-length lens configured to receive the object light that has passed through the first lens group, and capable of changing a focal length,
wherein an object that emits the object light undergoes focusing based on a power change in the variable-focal-length lens.

2. The optical system according to claim 1, further comprising a second lens group configured to receive the object light that has passed through the variable-focal-length lens, including one or more lenses, and having a positive power as a as a whole.

3. The optical system according to claim 1, wherein the variable-focal-length lens comprises a liquid lens.

4. The optical system according to claim 1, wherein the variable-focal-length lens comprises a lens composed of a soft polymer.

5. A camera module comprising:
the optical system according to claim 1; and
an image pickup unit having an image formation surface to which the object light that has passed through the optical system converges, and configured to subject the object light that has converged on the image formation surface to photoelectric conversion.

6. The camera module according to claim 5, further comprising a reflective element disposed opposite the variable-focal-length lens with respect to the first lens group of the optical system,
wherein the reflective element guides, along a second optical axis, the object light emitted along a first optical axis, the second optical axis intersecting with the first optical axis, and
the optical system concentrates the object light on the image formation surface along the second optical axis.
